(19) United States
(12) Patent Application Publication
(10) Pub. No.: US 2013/0066600 A1
(43) Pub. Date: Mar. 14, 2013

(54) METHOD AND APPARATUS FOR REAL-TIME LINE RATING OF A TRANSMISSION LINE

(71) Applicants: Adam Robert Rousselle, New Hope, PA (US); Vesa Johannes Leppanen, Doylestown, PA (US); Kevin Brzys, Stowe, VT (US)

(72) Inventors: Adam Robert Rousselle, New Hope, PA (US); Vesa Johannes Leppanen, Doylestown, PA (US); Kevin Brzys, Stowe, VT (US)

(73) Assignee: Utility Risk Management Corporation, LLC, Stowe, VT (US)

(21) Appl. No.: 13/601,137

(22) Filed: Aug. 31, 2012

Related U.S. Application Data
(60) Provisional application No. 61/530,033, filed on Sep. 1, 2011.

(51) Int. Cl. G06F 17/50

(52) U.S. Cl. 703/1

(57) ABSTRACT

A method of real-time line rating of a transmission line includes receiving, by a processor, real time transmission line conductor measurements of a transmission line having a plurality of conductor line segments from at least one real time line monitoring device. The processor generates a prediction model for at least one of the plurality of conductor line segments. Parameters of the at least one conductor line segment are predicted by the processor using the received transmission line conductor measurements and the prediction model and conductor locations of the at least one conductor line segment are simulated within a transmission line model based on the predicted parameters. The processor compares the conductor locations to one or more objects within the transmission line model determines conductor clearance distances between the simulated conductor locations and the one or more objects within the transmission line model.

### CROSS-REFERENCE TO RELATED APPLICATIONS

This application claims the benefit of U.S. Provisional Application Ser. No. 61/530,033 filed Sep. 1, 2011, entitled “Method and Apparatus to Determine Utility Line Clearance and Rating Condition in Real-Time,” which is incorporated herein by reference in its entirety.

### TECHNOLOGY FIELD

The present invention relates in general to the field of power line management, and, more particularly, to methods and systems for continuously monitoring temperature of an overhead electrical conductor at time of line usage.

### BACKGROUND

The power conductors of overhead power lines are self-supporting and energized at high voltage. As current flow through conductors increases, the temperature of the conductors increases, causing them to elongate. This elongation increases the sag of the conductors between support points, decreasing the clearance between the conductors and other objects, such as people, the ground surface, vegetation, vehicles, buildings and other structures proximate to the conductors of the transmission lines. Beyond certain “maximum allowable” sag, the lines may flashover, resulting in either a power supply outage, property damage or injury to the public.

Further, if conductor temperatures remain high for an extended period of time, the strength of the conductors and tensioned connectors may decrease, which could trigger mechanical failure during the next occurrence of ice or high wind loading. To avoid excessive sag or loss of strength, limits are placed on maximum operating temperature of the conductor. What is needed is an improved method and system for rating of transmission lines.

### SUMMARY

Embodiments of the present invention are directed to a method of real-time line rating of a transmission line that includes receiving, by a processor, real time transmission line conductor measurements of a transmission line having a plurality of conductor line segments from at least one real time line monitoring device and generating, by the processor, a prediction model for at least one of the plurality of conductor line segments. The method also includes predicting, by the processor, parameters of the at least one conductor line segment using the received transmission line conductor measurements and the prediction model and simulating, by the processor, conductor locations of the at least one conductor line segment within a transmission line model based on the predicted parameters. The method further includes comparing, by the processor, the conductor locations to one or more objects within the transmission line model and determining, by the processor, conductor clearance distances between the simulated conductor locations and the one or more objects within the transmission line model.

According to one embodiment, the method further includes identifying, by the processor, one or more clearance states of the conductor locations by comparing one or more of the conductor clearance distances to one or more predetermined minimum clearance values.

According to another embodiment, the identifying the clearance states of the conductor locations includes identifying conductor clearance distances as being equal to or less than one or more corresponding predetermined minimum clearance values.

In one aspect of an embodiment, the method, further includes informing a person or entity of one or more distances identified as being equal to or less than the one or more corresponding predetermined minimum clearance values.

In one embodiment, the identifying the clearance states of the conductor locations includes determining respective differences between the conductor clearance distances and the predetermined minimum clearance values.

According to an embodiment, the method further includes determining a maximum conductor current capacity of the at least one conductor line segment and determining a remaining conductor current capacity as the difference between the maximum conductor current capacity of the at least one conductor line segment and a present conduct current capacity of the at least one conductor line segment.

In an aspect of an embodiment, the simulating conductor locations includes simulating each of the conductor locations with increasing amounts of simulated current to the at least one line segment within the transmission line model until a respective conductor clearance distance is determined to be equal to or less than the one or more corresponding predetermined minimum clearance values. The method further includes determining the maximum conductor current capacity based on an amount of simulated current corresponding to the at least one line segment having a conductor clearance distance determined to be equal to or less than the one or more corresponding predetermined minimum clearance values.

In another aspect of an embodiment, the method further includes informing a person or entity of remaining conductor current capacity.

According to one embodiment, the simulating conductor locations includes simulating a first conductor location of the at least one of the plurality of line segments on the transmission line model based on a first predicted temperature at a first time and simulating a second conductor location of the at least one of the plurality of line segments on the transmission line model based on a second predicted temperature at a second time.

According to another embodiment, the comparing the conductor locations to one or more objects includes comparing the conductor locations to at least one of: (i) a ground surface; and (ii) objects other than the ground surface.

According to another embodiment, the receiving includes receiving real time transmission line conductor temperature measurements from the at least one real time line monitoring device.

In one embodiment of the invention, the receiving includes receiving real time transmission line conductor current measurements from the at least one real time line monitoring device.

In another embodiment of the invention, the receiving includes receiving real time transmission line condition measurements from the at least one real time line monitoring device, the transmission line condition measurements including air temperature, wind speed and direction, solar radiation, rainfall and air pressure.

According to one embodiment, the generating a prediction model includes generating an individual prediction model for each of the plurality of line segments.

According to another embodiment, the method further includes storing the transmission line model of the transmission line having the plurality of line segments.

In one embodiment, the storing the transmission line model includes storing a CAD model of the transmission line having the plurality of line segments.

In an aspect of an embodiment, the storing a CAD model includes storing a CAD model having data obtained via LiDAR. In another aspect, the storing a CAD model includes storing a CAD model having data obtained via a field survey. In another aspect, the storing a CAD model includes storing a CAD model having data obtained via thermal sensing.

According to one embodiment, the predicting of parameters of the at least one conductor line segment comprises predicting of temperatures of the at least one conductor line segment using the received transmission line conductor measurements and the prediction model.

Embodiments of the invention are directed to a method of real-time line rating of a transmission line that includes storing a CAD model of a transmission line having a plurality of line segments, receiving, by a processor, real time transmission line conductor measurements of a transmission line from at least one real time line monitoring device and generating, by the processor, a prediction model for at least one of the plurality of line segments. The method also includes predicting, by the processor, temperatures of at least one of the plurality of line segments using the received transmission line conductor measurements and the prediction model and simulating, by the processor, conductor locations of the at least one of the plurality of line segments within the CAD model based on the predicted temperatures. The method further includes comparing, by the processor, the conductor locations to one or more objects within the transmission line model to determine conductor clearance distances between the simulated conductor locations and the one or more objects within the transmission line model and identifying, by the processor, one or more clearance states of the conductor locations by comparing one or more conductor clearance distances to one or more clearance zones.

Embodiments of the invention are directed to a tangible computer readable medium that includes instructions for causing a processor to implement the steps of receiving real time transmission line conductor measurements of a transmission line having a plurality of conductor line segments from at least one real time line monitoring device and generating a prediction model for at least one of the plurality of conductor line segments. The steps also include predicting temperatures of the at least one conductor line segment using the received transmission line conductor measurements and the prediction model and simulating conductor locations of the at least one conductor line segment within a transmission line model based on the predicted temperatures. The steps further include comparing the conductor locations to one or more objects within the transmission line model and determining conductor clearance distances between the simulated conductor locations and the one or more objects within the transmission line model.

Embodiments of the invention are directed to a real-time transmission line rating system that includes a transmission line having a plurality of conductor line segments, at least one real time line monitoring device and a computing system. The computing system includes a receiver configured to receive real time transmission line conductor measurements of the transmission line from the at least one real time line monitoring device and one or more processors configured to: (i) predict temperatures of the at least one conductor line segment using the received transmission line conductor measurements; (ii) simulate conductor locations of the at least one conductor line segment within a transmission line model based on the predicted temperatures; (iii) compare the conductor locations to one or more objects within the transmission line model; and (iv) determine conductor clearance distances between the simulated conductor locations and the one or more objects within the transmission line model.

According to an embodiment, the processor is further configured to determine a maximum conductor current capacity of the at least one conductor line segment and determine a remaining conductor current capacity as the difference between the maximum conductor current capacity of the at least one conductor line segment and a present conduct current capacity of the at least one conductor line segment.

According to an aspect of an embodiment, the computing system further includes a transmitter configured to transmit information informing a person or entity of the remaining conductor current capacity.

In one embodiment, the processor is further configured to identify one or more clearance states of the conductor locations by comparing one or more of the conductor clearance distances to one or more predetermined minimum clearance values. The computing system further includes a transmitter configured to transmit information informing a person or entity of the one or more clearance states of the conductor locations.

### BRIEF DESCRIPTION OF THE DRAWINGS

FIG. 1 shows exemplary elements of a real-time line rating system that can be used with embodiments disclosed herein;

FIG. 2 is a perspective view of a span of a transmission line in a transmission line model that can be used with embodiments disclosed herein;

FIG. 3 is a profile view of three spans of a transmission line in a transmission line model that can be used with embodiments disclosed herein;

FIG. 4 is a system flow diagram illustrating a method of real-time line rating that can be used with the embodiments disclosed herein; and

FIG. 5 is a system flow diagram illustrating a method of determining remaining conductor current capacity that can be used with the embodiments disclosed herein.

### DETAILED DESCRIPTION

Embodiments of the invention include methods and systems that monitor utility lines in real-time, measuring their temperature and, in some aspects, other conditions, and simulate clearances in a transmission line model as a function of the line temperature and the other monitored conditions. Embodiments of the invention simulate conductor locations of line segments within a transmission line model based on predicted temperatures to provide simulated conductor clearances to objects within the transmission line model. Embodiments of the invention identify clearance states of the conductor locations by comparing the conductor clearance distances to predetermined minimum clearance values for vegetation management and/or other applications useful to electric utilities for safeguarding and optimizing the utility's transmission and distribution infrastructure. Embodiments of the invention use LiDAR (Light Detection And Ranging) to produce CAD (Computer Assisted Design) transmission line models of the utility lines.

As used in this document, a statement that a device or system is “in electronic communication with” another device or system means that devices or systems are configured to send data, commands and/or queries to each other via a communications network. The network may be a wired or wireless network such as a local area network, a wide area network, an intranet, the Internet or another network.

“CAD” refers to Computer Aided Design.

“Clearance” refers to a distance between a power line conductor and other objects.

“Clearance zone” refers to an area around a power line conductor that should be clear of obstructions to avoid arcing. Clearance zone may be defined in multiple different ways, and have different forms or shapes, depending on operating procedures, standards or regulations.

“LiDAR” refers to Light Detection and Ranging, which is a method and device that utilizes scanning laser distance measurements coupled with positioning to determine locations of objects. LiDAR typically produces point clouds that reflect location of object surfaces.

“Line loading” refers to the amount of power delivered through the line. Loading is normally expressed as Amperage.

“Power Line Rating” refers to determination of maximum operating capacity of a power line or line segment. In thermally constrained lines, the rating essentially defines the maximum operating temperature.

“Real time line monitoring device” refers to a device that measures one or more characteristics of a proximate power line segment.

“Sag” refers to the vertical distance between the highest and lowest point of the conductor catenary curve.

“Sagometer” refers to a device that measures the conductor sag on the line.

“Sway” refers to swaying movement of the power line conductor as a function of wind or other environmental conditions.

“Temperature Probe” refers to a contact device that measures temperature of an object.

“Tension monitor” refers to a device that measures the tension of the conductor.

“Thermal Sensing” refers to a method of utilizing thermal imaging for determining temperature of an object.

“Thermocouple” refers to an electronic contact device that measures the temperature of an object.

“Transmission line” refers to a single overhead power line circuit, regardless of its installation or setup method. Transmission line may include power lines called “transmission lines”, “distribution lines” “sub-transmission lines” “buses” “taps” or other names that indicate an overhead power line that transmits electric power. On multiple circuit lines, each circuit is considered as one line.

“Weather monitoring station” is a field station that monitors weather conditions such as wind speed, rainfall, solar radiation or temperature.

“Weather station” is a field station that records the data from the Weather monitoring station and, optionally, transmits it to a computing system or other location over Internet, cellular network, radio band, cable or other means of communication.

Power line rating is a process that determines the maximum safe operating capacity of the line conductors. A transmission line model, (e.g. a CAD model) of the transmission line may be generated based on line measurements. Then, the conductor model is evaluated, using simulation models, against higher conductor temperatures, predicting the elongation of the conductor and its corresponding location as function of the temperature. The modeled conductor location is used to measure clearance between the conductors and people, the ground, vegetation, buildings and vehicles in the proximity of the lines. The clearances are monitored at the maximum desired operating temperature of the line and the existence of the minimum clearances is verified in the CAD model.

Optionally, LiDAR can be used to produce the base line CAD models of power lines. LiDAR data may be collected using a sensor that is mounted to an aerial platform, tripod or a land vehicle. For clearance analysis during different conductor conditions, it may be advantageous to know the temperature at the time the LiDAR data was collected. LiDAR data may be captured simultaneously with or substantially simultaneous to weather and line loading data that allows modeling the conductor temperature or using direct thermal measurements of the conductor at time of LiDAR collection. In some embodiments, direct line temperature measurements at time of LiDAR collection are used during the LiDAR collection process.

In real-time line rating, the line temperature is monitored continuously on one or few control points with a thermal monitoring device and sent to computing system. A prediction formula producing the temperature of each span or line section may be generated and used as a part of line modeling. The prediction formula uses monitored line conditions and monitored temperature at control locations to continuously predict the temperature at each span or line section. These temperatures may be fed to the CAD-based simulation algorithm that defines clearances to objects of interest within the transmission line model. In some embodiments, violations or clearances that are equal to or less than minimum clearance value may be reported. In other embodiments, the remaining extra capacity (e.g. current that can be added before the conductor violates the minimum clearance values) may be estimated and reported.

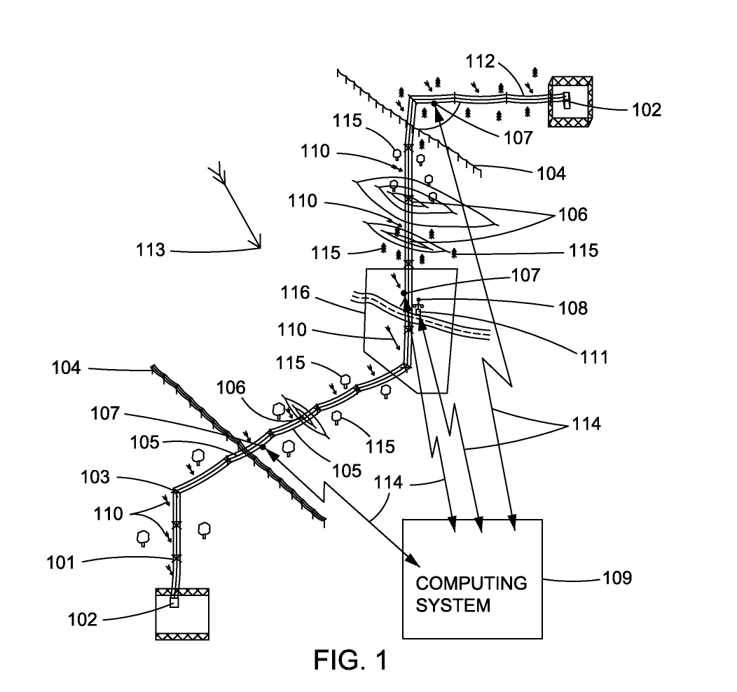

FIG. 1 shows exemplary elements of a real-time line rating system that can be used with embodiments disclosed herein. As shown in FIG. 1, the power transmission system includes a transmission line 101, which may be any transmission power line, and any number of substations 102. Typically, a transmission line transmits power between substations.

The system also may include dead-end structures 103, and crossing wires 104 of other power lines, telephone lines, data cables, etc. Dead-end structures 103 serve as endpoints or divide transmission lines into segments. Between dead-end structures 103, a line may be supported by any number of tangent structures that may further divide the line into additional segments or sub-segments. Each segment of the transmission line is typically tensioned separately. Segments can be divided to sub-segments for more accurate modeling and monitoring. Crossing wires and other constructions may cause clearance limitations when the transmission line conductor heats up.

The system may also include critical line rating spans 105, which are line segments where the ground clearance (or clearance to other objects, such as crossing lines, buildings or vegetation) limitation is first met when the line heats up. Clearances to critical points may be monitored in real time. Further, critical points may represent features with a high probability of first encroaching to the safety clearance buffer of the line when the line heats up. There may be critical locations 106 where the ground clearance criteria are typically met first when the conductor sags low.

The system may also include one or more real time line monitoring devices 107 and any number of conductors, such as conductors 112. One or more real time line monitoring devices 107 may be positioned on or near a conductor 112 of a line segment of transmission line 101. Real time line monitoring devices may include line temperature monitors or combined monitors that monitor line conditions such as temperature, current, tension and potentially other line conditions. Possible line monitors include, but are not limited to, attached temperature probes, thermocouples, sagometers, tension monitors, monitoring devices based on non-contact magnetic field monitoring or systems utilizing thermal imaging.

Environmental conditions may be monitored with local or remote real time condition monitoring devices 108, such as a weather station, that may be coupled with devices 111 for communicating with a computing system 109. Real time line condition monitoring devices 108 may monitor environmental conditions that include the overall average wind direction in the general area of the transmission line 101, as indicated by large arrow 113. Environmental condition measurements may also include the direction and speed of wind, indicated by arrows 110, monitored at more specific areas, such as areas near trees 115 and open areas 116. As shown at FIG. 1, the lengths of arrows 110 indicate wind speed at a respective area and the directions of arrows 110 indicate the wind direction at a respective area. Real time line condition monitoring devices 108 may also monitor environmental conditions that include air temperature, solar radiation, rainfall and air pressure.

Communications 114 between real time line monitoring devices 107, real time condition monitoring devices 108, devices 111 and computing system 109 may include any of the monitored line conditions, such as temperature, obtained from real time line monitoring devices 107 and/or environmental condition information obtained from real time condition monitoring devices 108. Computing 109 may contain one or more computers, each having one or more processors with software applications that perform functions, such as: (i) decoding of the data packages received from the monitoring devices 107 and 108; (ii) prediction of conductor element, span or line segment temperatures; (iii) performing the real time rating process, including simulations and clearance analysis by utilizing the predicted temperatures; and (iv) reporting information to one or more people or entities, such as the line loading and temperature information from the real time monitoring devices, as well as the analyzed maximum conductor capacity and remaining conductor capacity at any given time. These functions may be performed in computer hardware capable of running a CAD model of the line. Communication 114 may include one-way and two-way communication, allowing monitor configuration over a wired or wireless communication network.

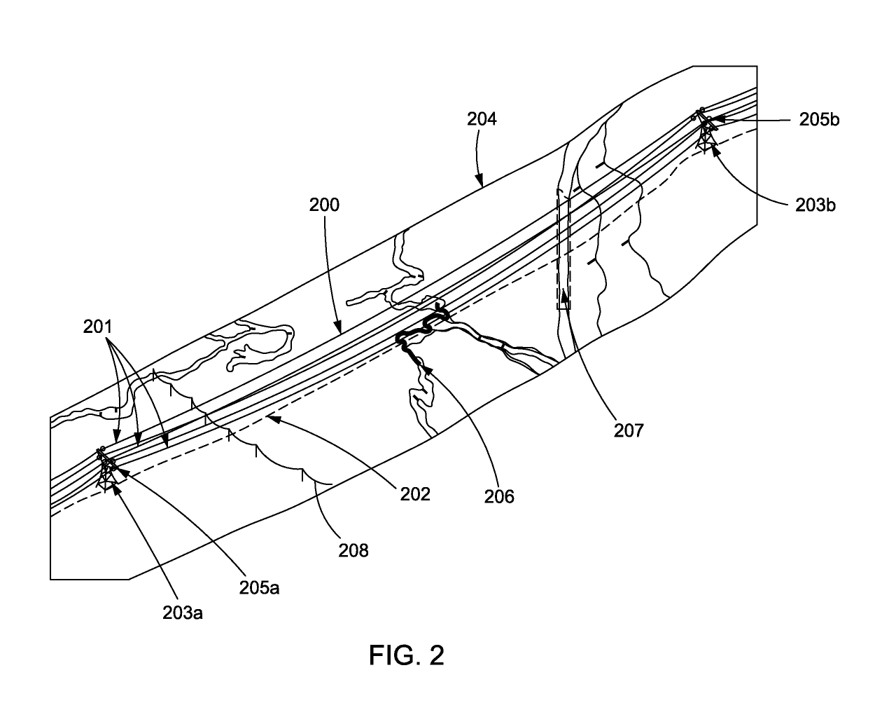

FIG. 2 is a perspective view of a transmission line span 200 within a transmission line model that can be used with embodiments disclosed herein. As shown in FIG. 2, the transmission line span 200 includes conductor locations 201 extending between support points 205 (sometimes called attachment points) where conductor locations 201 attach to insulators (not shown) of first transmission line tower 203a and second transmission line tower 203b. The transmission line span 200 within the transmission line model may also include crossing wires 208. Crossing wires 208 may have different minimum clearance values from conductor locations 201 than other objects, such as vegetation and ground surfaces. The transmission line span 200 within the transmission line model may also include ground surface 204 proximate to the transmission line span 200. Ground surface 204 may include waterways, such as stream 206, and road surfaces 207, which may have different minimum clearance values from conductor locations 201 than the minimum clearance values of other ground surfaces if the waterways 206 and road surfaces 207 are navigable.

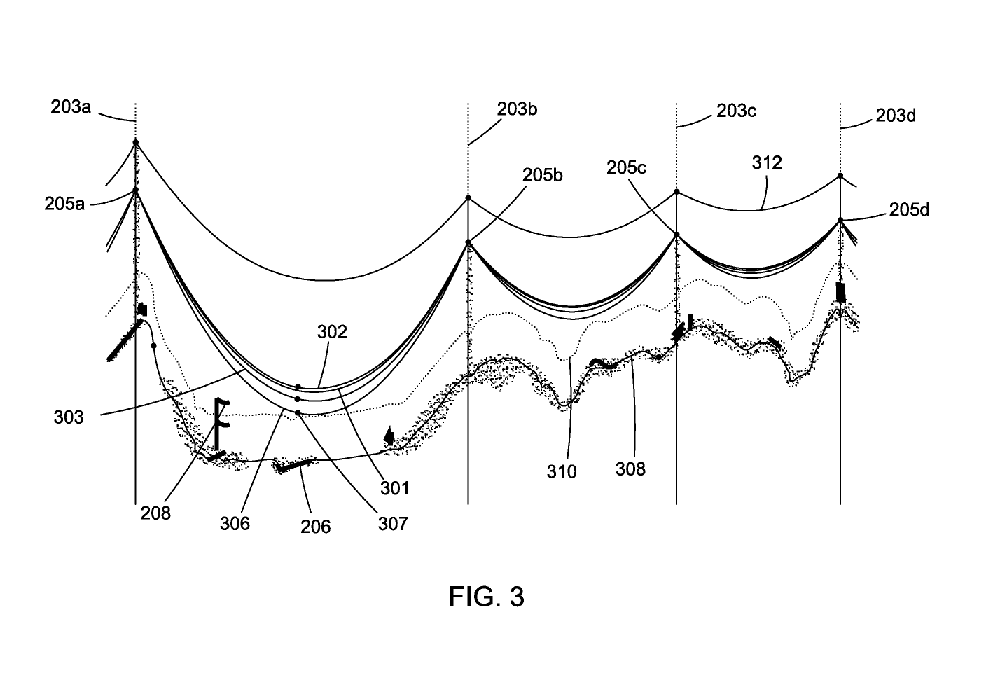

FIG. 3 is a profile view (vertical slice) along dashed profile line 202 (at FIG. 2) illustrating simulations of conductor locations 301, 302, 303 and 306 along three separate spans of the transmission line 200. Because FIG. 3 is a vertical slice along dashed profile line 202 at FIG. 2, the simulations of the conductor locations 301, 302, 303 and 306 indicate different locations of one of the conductors corresponding to the conductor locations 201 shown in FIG. 2.

The conductor location 301, shown at FIG. 3, indicates the location of the conductor at a time LiDAR data corresponding to the conductor was collected (hereinafter time of LiDAR collection) or substantially simultaneous to the time of LiDAR collection. Conductor location 302 indicates a location of the conductor at a conductor condition colder than the condition of the conductor at the time of LiDAR collection. Conductor location 303 indicates a location of the conductor at a conductor condition warmer than the condition of the conductor at the time of LiDAR collection. Conductor location 306 indicates a location of the conductor at the highest conductor temperature that still maintains the required safety clearance (e.g. minimum clearance value) to ground surface 308. Minimum clearance values to ground surface 308 along the spans of transmission line 200 are indicated by dotted line 310. Vertical dotted lines 203a and 203b corresponds to the location of the line towers 203a and 203b in the span shown at FIG. 2 and vertical dotted lines 203c and 203d correspond to the location of line towers (not shown at FIG. 2) along other spans of the transmission line. Support points 205a and 205b corresponds to the location of the support points 205a and 205b in the span shown at FIG. 2 and support points 205c and 205d correspond to the location of support points (not shown at FIG. 2) along the other spans of the transmission line. FIG. 3 also shows locations of an exemplary real time line temperature monitoring device 307 at points along the conductor locations 301, 302, 303 and 306 The profile also includes a shield wire 312, which may be used to protect conductors from falling objects, such as trees.

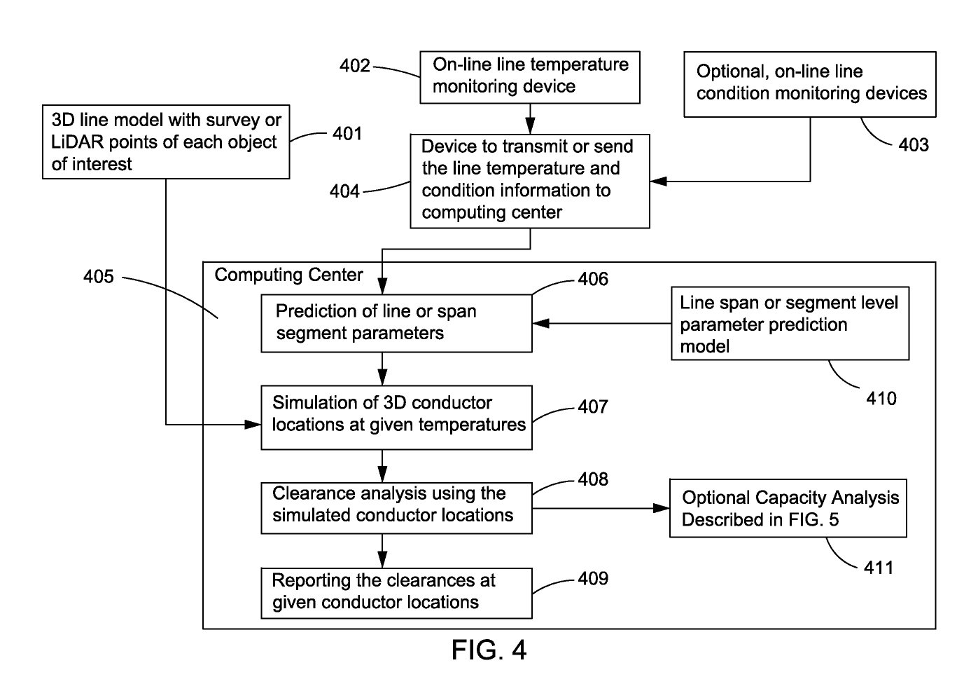

FIG. 4 is a system flow diagram illustrating a method of real-time line rating that can be used with the embodiments disclosed herein. As shown at FIG. 4, the computing system 109 may use information received from the models and devices shown at blocks 401-404. As shown at block 401, a transmission line model, such as a 3D CAD line model may be generated for a transmission line and objects of interest proximate to the transmission line based on data obtained from a field survey or LiDAR. For example, as shown at FIG. 2, a CAD transmission line model may include conductor locations 201 of conductor segments of transmission line 200 and temperature readings of the conductor segments obtained at the time of data collection. The CAD transmission line model shown at FIG. 2 also includes objects of interest, such as ground surface 204, stream 206, road surface 207 and crossing wires 208.

In some embodiments, a transmission line model, such as a CAD model of a transmission line, may be stored locally at the computing system 109 or stored remotely from the computing system 109 and sent via a wireless or wired network to the computing system 109 for processing.

In some embodiments, remote or local thermal sensing of the transmission line 200 may be used to establish the baseline line segment or span of the transmission line model, as described in U.S. patent application Ser. No. 13/212,684 entitled “Thermal Powerline Rating and Clearance Analysis Using Thermal Imaging Technology” or U.S. patent application Ser. No. 13/212,689 entitled “Thermal Powerline Rating and Clearance Analysis Using Local Thermal Sensor,” which are incorporated in their entirety.

According to some embodiments, transmission line models, such as 3D CAD models may include any combination of different types of location data and/or measurement data, such as conductor locations in 3D space, conductor support points to insulators, conductor type and weight, conductor tension, conductor temperature, location of line structures, ground surface location in 3D space and location of objects of interest in the vicinity of the transmission line in 3D space. Objects of interest or obstructions may potentially violate minimum clearance values or a clearance zone of the conductors if the conductor sags or sways far enough. In some embodiments, objects of interest may be classified to different types, such as, for example, ground (sometimes water surfaces are separated from ground, since they may follow flooding or tidal cycles), man-made constructions (man-made constructions can be further classified to billboards, houses, roads, crossing wires, poles, etc.) and vegetation. The objects of interest may include crossing wires or cables, poles, buildings, vegetation, traffic signs, water surfaces, road surfaces, and billboards. In some embodiments, the transmission line model may calculate a conductor location by locating the conductor attachment points to insulators, and modeling sag-tension with a finite element model, a ruling span model or with any applicable technique. Conductor locations may be modeled, for example, using PLS-CADD software or SAGSEC software. Optionally, LiDAR data can be used to generate obstruction measurement point clouds. LiDAR returns can be classified to represent different obstruction classes, providing point classes that are used as models of obstructions.

As shown at block 402, real time transmission line conductor measurements, (e.g. conductor temperature, conductor current and conductor tension) of transmission line 200 may be monitored by real time line monitoring device 402 to continuously, substantially continuously, frequently or periodically monitor conductor conditions, such as conductor temperature. In some aspects, a real time line monitoring device 402 may be a local monitoring device (e.g. coupled to the transmission line 200). In some aspects, a real time line monitoring device 402 may be a remote monitoring device, such as thermal sensor (e.g. an infrared imaging camera, such as described in U.S. patent application Ser. No. 13/212,684 entitled “Thermal Powerline Rating and Clearance Analysis Using Thermal Imaging Technology,” which is incorporated by reference in its entirety).

In some embodiments, as shown at block 403, local or remote real time transmission line condition measurements, such as air temperature, wind speed and direction, solar radiation, rainfall and/or air pressure may be monitored by real time line condition monitoring device 402, such as weather station 108, which may include: Wireless Vantage Pro2™ with Standard Radiation Shield; stations available from Davis Instruments Corp; RS210-WS Complete Weather Station Package available from Ranch Systems; and other stations capable of providing similar functionality.

The real time transmission line conductor measurements and real time transmission line condition measurements may be transmitted via a wired or wireless network to computing system 109. In some embodiments, a real time line monitoring device 402 and/or 403 may include device 404 to send the real time transmission line measurements to the computing system 109 and to receive information from the computing system 109. The real-time line monitoring device 402 and/or 403 may be monitored during the modeling data collection, to allow modeling of conductor line segments of the transmission line 200, conductor line segment temperatures and other objects of interest as a function of the real time monitoring device readings.

As shown at block 406, computing system 109 may receive the real time transmission line conductor measurements of transmission line 200, such as conductor temperature and conductor current measurements, from at least one real time line monitoring device 402 and the real time transmission line condition measurements from the at least one real time line condition monitoring device 403. Computing system 109 may then predict temperatures of at least one conductor line segment of transmission line 200 using the received transmission line measurements from monitoring devices 402 and 403 and a prediction model 410 generated for the at least one conductor line segment of transmission line 200. Predicted parameters may be any parameters that are used in the line analysis, including conductor temperature, effective conductor temperature, conductor surface temperature, conductor creep, thermal expansion coefficient of the conductor, conductor sag, correction factor for conductor sag, wind speed and direction, wind speed across conductor, cooling effect of wind, ambient temperature and solar heating.

In some embodiments, the prediction model may be generated by computing system 109. In other embodiments, the prediction model may be generated separate from and sent to computing system 109.

The line span or segment level temperature prediction model 410 may be used to predict the line span or segment level temperature as a function of the real time transmission line temperature monitoring device measurements. In some embodiments, an individual line span or segment temperature prediction model may be generated for each line segment of transmission line 200.

Preliminary model information or data from other similar transmission lines may be utilized to define the model shape and parameters. In some aspects, thermal line imaging technology may be utilized to initially and/or continuously determine and monitor the line segment or span temperatures for the modeling data, as described in U.S. patent application Ser. No. 13/212,684 entitled “Thermal Powerline Rating and Clearance Analysis Using Thermal Imaging Technology,” which is incorporated in its entirety.

In some embodiments, the modeling of the individual span temperatures can be made by dividing the transmission line 200 into sections where the individual span temperatures are homogenous. In some aspects, each of the segments may be equipped with one or more real time (e.g. on-line) transmission line temperature monitoring devices, such as monitoring device 402, and the device measurements may be applied to all spans of the transmission line 200.

In other embodiments, a set of line temperature monitoring devices, such as a set of monitoring devices 402, may be installed along the line and a model between conductor temperatures on each span as a function of selected monitored span may be generated, using line conditions and conductor temperature on the selected monitored span as predictors. In some aspects, conductor temperature monitoring devices 402 may be installed on several spans, and removed after the modeling period is completed.

As shown at block 407, computing system 109 may simulate conductor locations 301, 302, 303 and 306 of a conductor of transmission line 200 within a transmission line model based on the predicted parameters. For example, computing system 109 may simulate a conductor location 301 of a conductor at a time of LiDAR collection or substantially simultaneous to the time of LiDAR collection. Computing system 109 may then simulate other conductor locations of the conductor based on the predicted parameters from the prediction model 410. For example, based on a predicted temperature that is colder than the condition of the conductor at the time of LiDAR collection, computing system 109 may simulate a conductor location 302 of the conductor at the colder temperature. As shown at FIG. 3, the conductor location 302 indicates less sag than conductor location 301 and is farther away from minimum clearance value above ground, indicated by dotted line 310.

Based on a predicted temperature that is warmer than the condition of the conductor at the time of LiDAR collection, computing system 109 may also simulate conductor location 303 of the conductor at the warmer temperature. As shown at FIG. 3, the conductor location 303 indicates more sag than conductor location 301 and is closer to the minimum clearance value above ground (closer to a violation of the minimum clearance), indicated by dotted line 310. In some embodiments, the predicted parameter may result in the computing system 109 simulating a conductor location 306 of the conductor, indicating a maximum sag conductor location or a conductor location at the highest conductor temperature that still maintains the required safety clearance (e.g. minimum clearance value) to ground surface 308.

As shown at block 408, computing system 109 may perform a clearance analysis using the simulated conductor locations 301, 302, 303 and 307. The clearance analysis may include comparing the conductor locations 301, 302, 303 and 307 (e.g. portions of the conductor locations closest to an object) to one or more objects within the transmission line model. Conductor clearance distances may then be determined between the simulated conductor locations 301, 302, 303 and 307 and the one or more objects 308 within the transmission line model. For example, computing system 109 may compare the conductor location 301 to the ground surface 308 and may, for example, determine a conductor clearance distance of 14 feet between conductor location 301 and ground surface 308. Computing system 109 may also compare the other conductor locations 302, 303 and 307 to the ground surface 308. Accordingly, computing system 109 may determine a conductor clearance distance of 15 feet between conductor location 302 and ground surface 308, a conductor clearance distance of 12 feet between conductor location 303 and ground surface 308 and a conductor clearance distance of 10 feet between maximum sag conductor location 307 and ground surface 308.

In some aspects, the conductor locations 301, 302, 303 and 307 may be compared to objects (not shown at FIG. 3) other than ground surface, such as vegetation, crossing wires and other man-made objects and conductor clearance distances may be determined between the simulated conductor locations 301, 302, 303 and 307 and the objects other than ground surface 308 within the transmission line model.

The clearance analysis at block 408 may also include identifying one or more clearance states of the conductor locations 301, 302, 303 and 306 by comparing one or more of the conductor clearance distances to one or more predetermined minimum clearance values (e.g. portion of minimum clearance closest to a corresponding conductor location), such as the minimum clearance value 310 from ground 308. For example, assuming the minimum clearance value 310 from ground surface 308 is 10 feet, the conductor clearance distance (12 feet from ground surface 308) corresponding to conductor location 303 may compared to predetermined minimum clearance value 310. A clearance state for conductor location 303 may then be identified as a compliance state because the conductor clearance distance (12 feet from ground surface 308) is greater than the minimum clearance value of 10 feet from ground surface 308. The conductor clearance distance (10 feet from ground surface 308) corresponding to conductor location 306 may also be compared to predetermined minimum clearance value 310. A clearance state for conductor location 306 may then be identified as being in a state of violation because the conductor clearance distance (10 feet from ground surface 308) is equal to the minimum clearance value of 10 feet from ground surface 308. By contrast, a conductor location may be identified as being in a state of violation if the conductor clearance distance is equal to or greater than the minimum clearance value. In some embodiments, a conductor location may be identified as being in a state of violation if the conductor clearance distance is greater than the minimum clearance value. A person or entity may be informed of one or more distances that are identified as equal to or less than the one or more corresponding predetermined minimum clearance values.

In some embodiments, the clearance states of the conductor locations 301, 302, 303 and 306 may be identified by determining respective differences between the conductor clearance distances and the predetermined minimum clearance values 310. For example, a clearance state for conductor location 303, having a conductor clearance distance of 12 feet from ground surface 308, may be identified as being in a state of having a difference of +2 feet from the predetermined minimum clearance value of 10 feet from ground surface 308. A clearance state for conductor location 306, having a conductor clearance distance of 10 feet from ground surface 308, may be identified as being in a state of having a difference of 0 feet from the predetermined minimum clearance value of 10 feet from ground surface 308. Although not shown in FIG. 3, a clearance state for a conductor location having a conductor clearance distance less than 10 feet from ground surface 308 may be identified as being in a state of having a difference of negative feet from the predetermined minimum clearance value of 10 feet from ground surface 308.

In some embodiments, the clearance states of the conductor locations 301, 302, 303 and 306 may be identified by comparing one or more conductor clearance distances to one or more clearance zones. A clearance zone refers to an area around a power line conductor that should be clear of obstructions to avoid arcing. A clearance zone may be any area around or one or more segments of a power line conductor. The clearance zone may include any 2D or 3D geometric shape. The edges of the clearance zone may be determined as a maximum distance from conductor locations. The edges of the clearance zone may also be determined as a distance from objects of interest such as ground surface 308 and objects other than ground surface 308.

According to some embodiments, new simulations of conductor locations may be continuously repeated, at block 407, based on continuous predicted parameters being received in real time at block 406. Accordingly, a clearance analysis may also be continuously repeated for each conductor location being simulated.

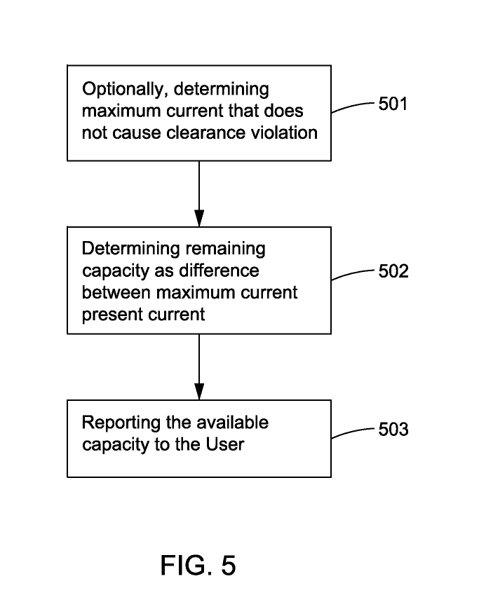

In some embodiments, a capacity analysis may be performed to determine the remaining conductor current capacity, as shown at block 411. FIG. 5 is a system flow diagram illustrating a method of determining remaining conductor current capacity that can be used with the embodiments disclosed herein. As shown at FIG. 5, a maximum conductor current capacity of a conductor line segment of transmission line 200 may be determined at block 501, and the remaining conductor current capacity may be determined as the difference between the maximum conductor current capacity of the conductor line segment of transmission line 200 and a present (e.g. at a time of LiDAR collection or at a predicted temperature) conduct current capacity of the conductor line segment at block 502.

The maximum current capacity of a conductor may be determined as the amount of current in a conductor when the conductor location has a conductor clearance distance equal to the minimum clearance value. Accordingly, any more current added to a conductor at its maximum current capacity may result in a violation of the minimum clearance value. At block, 503, a person or entity may be informed of remaining conductor current capacity. The person or entity may be informed by the computing system 109 visually or aurally and may include sending the remaining capacity locally or remotely via a wired or wireless network.

In some embodiments, the remaining current capacity of a conductor may be determined by simulating each of the conductor locations 301, 302, 303 and 306 with increasing amounts of simulated current until a respective conductor clearance distance is determined to be equal to or less than the corresponding predetermined minimum clearance value and then determining the maximum conductor current capacity based on an amount of simulated current of the conductor having a clearance distance equal to or less than the corresponding predetermined minimum clearance value. The remaining conductor current capacity may be determined as the difference between the maximum conductor current capacity of the conductor line segment of transmission line 200 and a present (e.g. at a time of LiDAR collection or at a predicted temperature) conduct current capacity of the conductor line segment at block 502.

In some embodiments, instructions for performing any of the processes described in this document may be stored on a tangible computer readable medium. For example, the instructions stored on the tangible computer readable medium may cause one or more processors in computing system 109 to implement the steps of: (i) receiving real time transmission line conductor measurements of a transmission line having a plurality of conductor line segments from at least one real time line monitoring device; (ii) generating a prediction model for at least one of the plurality of conductor line segments; (iii) predicting temperatures of the at least one conductor line segment using the received transmission line conductor measurements and the prediction model; (iv) simulating conductor locations of the at least one conductor line segment within a transmission line model based on the predicted parameters; (v) comparing the conductor locations to one or more objects within the transmission line model; and (vi) determining conductor clearance distances between the simulated conductor locations and the one or more objects within the transmission line model.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A method of real-time line rating of a transmission line, comprising:
receiving, by a processor, real time transmission line conductor measurements of a transmission line having a plurality of conductor line segments from at least one real time line monitoring device;
generating, by the processor, a prediction model for at least one of the plurality of conductor line segments;
predicting, by the processor, parameters of the at least one conductor line segment using the received transmission line conductor measurements and the prediction model;
simulating, by the processor, conductor locations of the at least one conductor line segment within a transmission line model based on the predicted parameters;
comparing, by the processor, the conductor locations to one or more objects within the transmission line model; and
determining, by the processor, conductor clearance distances between the simulated conductor locations and the one or more objects within the transmission line model.

2. The method of claim 1, further comprising identifying, by the processor, one or more clearance states of the conductor locations by comparing one or more of the conductor clearance distances to one or more predetermined minimum clearance values.

3. The method of claim 1, wherein the identifying the clearance states of the conductor locations comprises identifying conductor clearance distances as being equal to or less than one or more corresponding predetermined minimum clearance values.

4. The method of claim 3, further comprising informing a person or entity of one or more distances identified as being equal to or less than the one or more corresponding predetermined minimum clearance values.

5. The method of claim 1, wherein the identifying the clearance states of the conductor locations comprises determining respective differences between the conductor clearance distances and the predetermined minimum clearance values.

6. The method of claim 1, further comprising:
determining a maximum conductor current capacity of the at least one conductor line segment; and
determining a remaining conductor current capacity as the difference between the maximum conductor current capacity of the at least one conductor line segment and a present conduct current capacity of the at least one conductor line segment.

7. The method of claim 6, wherein the simulating conductor locations comprises simulating each of the conductor locations with increasing amounts of simulated current to the at least one line segment within the transmission line model until a respective conductor clearance distance is determined to be equal to or less than the one or more corresponding predetermined minimum clearance values, and
the method further comprises:
determining the maximum conductor current capacity based on an amount of simulated current corresponding to the at least one line segment having a conductor clearance distance determined to be equal to or less than the one or more corresponding predetermined minimum clearance values.

8. The method of claim 6, further comprising informing a person or entity of remaining conductor current capacity.

9. The method of claim 1, wherein the simulating conductor locations comprises:
simulating a first conductor location of the at least one of the plurality of line segments on the transmission line model based on a first predicted temperature at a first time; and
simulating a second conductor location of the at least one of the plurality of line segments on the transmission line model based on a second predicted temperature at a second time.

10. The method of claim 1, wherein the comparing the conductor locations to one or more objects comprises comparing the conductor locations to at least one of: (i) a ground surface; and (ii) objects other than the ground surface.

11. The method of claim 1, wherein the receiving comprises receiving real time transmission line conductor temperature measurements from the at least one real time line monitoring device.

12. The method of claim 1, wherein the receiving comprises receiving real time transmission line conductor current measurements from the at least one real time line monitoring device.

13. The method of claim 1, wherein the receiving comprises receiving real time transmission line condition measurements from the at least one real time line monitoring device, the transmission line condition measurements including air temperature, wind speed and direction, solar radiation, rainfall and air pressure.

14. The method of claim 1, wherein the generating a prediction model comprises generating an individual prediction model for each of the plurality of line segments.

15. The method of claim 1, wherein the method further comprises storing the transmission line model of the transmission line having the plurality of line segments.

16. The method of claim 15, wherein the storing the transmission line model comprises storing a CAD model of the transmission line having the plurality of line segments.

17. The method of claim 16, wherein the storing a CAD model comprises storing a CAD model having data obtained via LiDAR.

18. The method of claim 16, wherein the storing a CAD model comprises storing a CAD model having data obtained via a field survey.

19. The method of claim 16, wherein the storing a CAD model comprises storing a CAD model having data obtained via thermal sensing.

20. The method of claim 1, wherein the predicting of parameters of the at least one conductor line segment comprises predicting of temperatures of the at least one conductor line segment using the received transmission line conductor measurements and the prediction model.

21. A method of real-time line rating of a transmission line, comprising:
storing a CAD model of a transmission line having a plurality of line segments;
receiving, by a processor, real time transmission line conductor measurements of a transmission line from at least one real time line monitoring device;
generating, by the processor, a prediction model for at least one of the plurality of line segments;
predicting, by the processor, temperatures of at least one of the plurality of line segments using the received transmission line conductor measurements and the prediction model;
simulating, by the processor, conductor locations of the at least one of the plurality of line segments within the CAD model based on the predicted temperatures;
comparing, by the processor, the conductor locations to one or more objects within the transmission line model to determine conductor clearance distances between the simulated conductor locations and the one or more objects within the transmission line model; and
identifying, by the processor, one or more clearance states of the conductor locations by comparing one or more conductor clearance distances to one or more clearance zones.

22. A tangible computer readable medium comprising instructions for causing a processor to implement the steps of:
receiving real time transmission line conductor measurements of a transmission line having a plurality of conductor line segments from at least one real time line monitoring device;
generating a prediction model for at least one of the plurality of conductor line segments;
predicting temperatures of the at least one conductor line segment using the received transmission line conductor measurements and the prediction model;
simulating conductor locations of the at least one conductor line segment within a transmission line model based on the predicted temperatures;
comparing the conductor locations to one or more objects within the transmission line model; and
determining conductor clearance distances between the simulated conductor locations and the one or more objects within the transmission line model.

23. A real-time transmission line rating system comprising:
a transmission line having a plurality of conductor line segments;
at least one real time line monitoring device; and
a computing system comprising:
a receiver configured to receive real time transmission line conductor measurements of the transmission line from the at least one real time line monitoring device; and
one or more processors configured to: (i) predict temperatures of the at least one conductor line segment using the received transmission line conductor measurements; (ii) simulate conductor locations of the at least one conductor line segment within a transmission line model based on the predicted temperatures; (iii) compare the conductor locations to one or more objects within the transmission line model; and (iv) determine conductor clearance distances between the simulated conductor locations and the one or more objects within the transmission line model.

24. The rating system of claim 23, wherein the processor is further configured to:
determine a maximum conductor current capacity of the at least one conductor line segment; and
determine a remaining conductor current capacity as the difference between the maximum conductor current capacity of the at least one conductor line segment and a present conduct current capacity of the at least one conductor line segment.

25. The rating system of claim 24, wherein the computing system further comprises a transmitter configured to transmit information informing a person or entity of the remaining conductor current capacity.

26. The rating system of claim 23, wherein,
the processor is further configured to identify one or more clearance states of the conductor locations by comparing one or more of the conductor clearance distances to one or more predetermined minimum clearance values, and
the computing system further comprises a transmitter configured to transmit information informing a person or entity of the one or more clearance states of the conductor locations.
